(19) United States
(12) Patent Application Publication
(10) Pub. No.: US 2007/0208104 A1
(43) Pub. Date: Sep. 6, 2007

(54) ANTIMICROBIAL PLASTICS COMPOSITION WITH LOW ELUTION RATE AND WITH LONG PERIOD OF ACTIVITY

(76) Inventors: Heinz Pudleiner, Krefeld (DE); Joachim Hyner, Langenfeld (DE)

Correspondence Address: Womble Carlyle Sandridge & Rice, PLLC;Attn: Patent Docketing 32nd Floor, P.O. Box 7037, Atlanta, GA, 30357-0037, US

(21) Appl. No.: 11/539,279

(22) Filed: Oct. 6, 2006

(30) Foreign Application Priority Data
Oct. 6, 2005 (DE) 102005048131.0

(51) Int. Cl. C09D 5/16; C08K 5/34

(52) U.S. Cl. 523/122; 524/99

(57) ABSTRACT

The present invention relates to antimicrobial plastics compositions comprising a thermoplastic elastomer (TPE), particularly thermoplastic polyurethanes, and of at least one antimicrobial active ingredient from the group of the bis(4-amino-1-pyridinium)alkanes, specifically octinidine. The present invention also relates to the preparation of these compositions, and also to the use of these plastics compositions for catheters and other applications including medical-technology products.

### CROSS REFERENCE TO A RELATED APPLICATION

This application claims priority to German Application No. 102005048131.0 filed Oct. 6, 2005, the contents of which are incorporated herein by reference in its entirety.

### BACKGROUND OF THE INVENTION

1. Field of the Invention

The present invention relates generally to antimicrobial plastics compositions made of a thermoplastic elastomer (TPE), particularly thermoplastic polyurethanes, and of at least one antimicrobial active ingredient selected from the group of the bis(4-amino-1-pyridinium)alkanes, specifically octinidine. The present invention further relates to the preparation of these compositions, and also to the use of these plastics compositions such as for catheters and other medical-technology products.

2. Description of Related Art

The use of polymeric organic materials has now become an integral part of daily life. Workpieces formed of organic materials are naturally susceptible, under the various conditions of their use, to being contaminated by a very wide variety of microorganisms, such as bacteria, viruses or fungi. This poses risks related to hygiene factors and to medical factors in the environment of the workpiece and also in the function and/or use of the workpiece itself, the latter being applicable if undesired microbiological degradation of the material occurs.

In particular, the use of polymeric materials for diagnostic and therapeutic applications has led to a significant advance in technology in modern medicine. On the other hand, the frequent use of these materials in medicine has led to a dramatic rise in what are known as foreign-body infections or polymer-associated infections.

In addition to traumatic and thromboembolic complications, catheter-associated infections including even sepsis are a serious problem with use of venous access devices in medicine, in particular in intensive care.

Numerous studies have shown that coagulase-negative staphylococci, the transient microbe Staphylococcus aureus, Staphylococcus epidermis and various Candida species are substantial causes of catheter-associated infections. During application of the catheter, these micro-organisms, which are ubiquitously or naturally present on the skin, penetrate the physiological barrier of the skin and thus reach the subcutaneous region and eventually the bloodstream. Adhesion of the bacteria to the plastic surface is generally regarded as necessary for the pathenogenesis of foreign-body infections to take place. Adhesion of the cutaneous organisms to the polymer surface is followed by the start of metabolically active proliferation of the bacteria that eventually colonizes in or on the polymer. The occurrence of colonization is associated with production of a biofilm through bacterial excretion of extracellular glycocalix.

The presence of a biofilm also contributes to the undesired contamination in other way as well. For example, the biofilm allows adhesion of the pathogens and protects them from attack by certain cells of the immune system. In addition, the film forms a barrier impenetrable by many antibiotics. Extensive proliferation of the pathogenic microbes on the polymer surface may finally be followed by septic bacteriaemia. Therapy of such infections requires removal of the infected catheter because antibiotic therapy would require doses of antibiotic that are unphysiologically high, that is, dangerous to the subject being treated.

The incidence of bacterially induced infections with central venous catheters averages about 5%. Overall, central venous catheters prove to be responsible for about 90% of all cases of sepsis in intensive care. The use of central venous catheters therefore, not only involves a higher risk of infection for the patients, but also causes extremely high follow-up therapy costs (subsequent treatment, extended stays in clinics, and sometimes invalidity, death).

Pre-, peri- or post-operative measures (e.g. hygiene measures, etc.) are only a partial solution to these problems. A rational strategy for prevention of polymer-associated infections involves a modification of the polymeric materials used. The aim of this modification has to be inhibition of adhesion of bacteria and, respectively, of proliferation of existing adherent bacteria, for causal prevention of foreign-body infections. By way of example, this can be achieved by incorporating a suitable chemotherapeutic agent into the polymer matrix (e.g. antibiotics and/or antiseptics), provided that the incorporated active ingredient can also diffuse out of the polymer matrix. In this case, it is possible to extend the release of the antimicrobial active ingredient over a prolonged period, and thus inhibit for a correspondingly prolonged period the processes of adhesion of microbes or, more precisely adhesion of bacteria and, respectively, their proliferation on the polymer.

There are previously known methods for the preparation of antimicrobially modified polymers. The microbicides in such known methods are applied onto the surface, onto a surface layer or introduced into the polymeric material. The following techniques have been described for thermoplastic polyurethanes, which have been particularly used for medical applications:
a) adsorption on the polymer surface (passively or via surfactants)
b) introduction into a polymer coating which is applied on the surface of a molding
c) incorporation into the bulk phase of the polymeric substrate material
d) covalent bonding to the polymer surface
e) mixing with a polyurethane-forming component prior to the reaction to give the finished polymer.

By way of example, EP 0 550 875 B1 discloses a process for introducing active ingredients into the outer layer of medical items (impregnation). In this process, the implantable apparatus composed of polymeric material is swollen in a suitable solvent. This alters the polymer matrix to the extent that it becomes possible for a pharmaceutical active ingredient or an active ingredient combination to penetrate into the polymeric material of the implant. Once the solvent has been removed, the active ingredient is present within the polymer matrix. After contact with the physiological medium, the active ingredient present in the implantable apparatus is in turn released via diffusion. The release profile can be adjusted within certain limits via the selection of the solvent and via variation of the experimental conditions.

Polymeric materials which are intended for medical applications and which have coatings comprising active ingredient are mentioned by way of example in U.S. Pat. No. 5,019,096. In this patent, processes are described for the production of antimicrobially active coatings, and methods are described for their application to the surfaces of medical devices. The coatings are made of a polymer matrix, in particular of polyurethanes, of silicones, or of biodegradable polymers, and of an antimicrobially active substance, preferably of a synergistic combination of a silver salt with chlorhexidine or with an antibiotic.

U.S. Pat. No. 5,281,677 describes blends of TPU which are preferably used for the production of multiple-lumen vascular catheters. This patent mentions that the moldings can also comprise an antimicrobial active ingredient, which can have been bulk-distributed in one of the polyurethanes prior to being processed in the melt.

U.S. Pat. No. 6,120,790 describes thermoplastic resins which comprise antimicrobial or fungistatic active ingredients, where the polymer contains a polyether chain as unit. Among organic compounds, pyridines could also be used as active ingredients, but these are not specified as an example in this patent.

EP 927 222 A1 describes the introduction of substances having antithrombic or antibiotic action into a reaction mixture for preparation of a TPU.

WO 03/009879 A1 describes medical products with microbicides in a polymeric matrix, where the surface has been modified with biosurfactants. Various techniques can be used to introduce the active ingredients into the polymer. The surfactants serve to reduce adhesion of the bacteria on the surface of the molding.

U.S. Pat. No. 5,906,825 describes polymers, among which are polyurethanes, in which biocides and, respectively, antimicrobial agents (specific description in the patent being exclusively of plant ingredients) have been dispersed, the amount being sufficient to suppress the growth of microorganisms coming into contact with the polymer. This suppression of growth can be optimized by the addition of an agent that regulates the migration and/or release of the biocide. Naturally occurring substances such as vitamin E are mentioned. Food packaging is the main application.

Zbl. Bakt. 284, 390-401 (1996) describes improved action over a long period of antibiotics dispersed in a silicone polymer matrix or polyurethane polymer matrix, in comparison with antibiotics applied via a deposition technique to the surface or antibiotics introduced in the vicinity of the surface via a technique involving incipient swelling. In such a system as described in this patent, the high initial rate of release of the antibiotic from the surface into an ambient aqueous medium is subject to very marked, non-reproducible variations.

U.S. Pat. No. 6,641,831 describes medical products with reduced propensity for pharmacological activity, this being controlled via introduction of two substances having different levels of lipophilic properties. The core of the system described is the effect that the release rate of an antimicrobial active ingredient is reduced via addition of a more lipophilic substance. The result is that release is maintained over a longer period. It is said to be preferable that the active ingredient does not have high solubility in aqueous media. It is also disclosed that the release of disinfectants can be delayed, and, inter alia, octenidene mentioned.

JP 08-157641 describes a process for preparation of antimicrobial materials via kneading a pulverulent active ingredient, preferably chlorhexidine, into the melt, a polymer, among which is polyurethane. The specific surface area of the polymer is greater than or equal to 17 cm²/g.

CN 1528470 A describes a process for production of a medical anti-infection insertion guide tube for catheters made of polyurethane. The process involves a masterbatch termed a mother material, which comprises the antimicrobial agent, which is mixed with the PU raw material and is extruded to give the molding.

WO 2004/017738 A describes compositions formed of polymers and of colloidal, oligodynamic agents, these inhibiting formation of a microbial film on the surface. Optionally, these can also comprise other pharmaceutical active ingredients. Among a list of a large number of active ingredients given as examples, antimicrobial active ingredients are mentioned as being typical, and octenidine hydrochloride is mentioned among these.

DE 27 08 331 C2 (Sterling Drug Inc.) describes the preparation of bis(4-substituted-amino-1-pyridinium), among which is octenidine. An application sector mentioned is inhibition of formation of dental plaque. The material is not used to modify polymers.

EP 1 123 927 A1 describes an improved process for preparation of the active ingredients from the group of the bis(4-amino-1-pyridinium)alkanes, among these octenidine. Application sectors mentioned are soaps, shampoos, disinfectants, e.g. for disinfecting the skin prior to surgery, paints and lacquers. There are no details of use for eliminating catheter-associated infections.

Antimicrobial modification via use of antibacterial active ingredients with specific activity, i.e. antibiotics, is controversial, as also is their topical application in medicine. The reason for this controversy is the known risk of the development of resistance during systemic administration. WO 2005/009495 A proposes a solution to this problem by disclosing the use of antiseptics in polymethyl methacrylate bone cements. Possible substances mentioned inter alia, but not preferred, are pyridine derivatives, such as octenidine dihydrochloride, but preference is given to polyhexamethylene biguanidide (PHMB).

A factor common to all of the methods mentioned is that the time-limited action of the antimicrobial modification of the moldings made of a polymeric material, in particular of medical products, is optimized over a long period during use on or in a patient. However, present methods do not satisfactorily achieve this extended time antimicrobial effect while simultaneously eliminating the risk of initial microbial infection of the molding itself or infection of humans or animals via the molding.

### SUMMARY OF THE INVENTION

The present application is therefore particularly targeted at medical products which are mainly used intracorporally. By way of example, catheters generally penetrate the surface of the body for the entire period of their use and therefore pose particularly high risk of microbial infection. The risk of initial infection on introduction of the medical products into the body via microbial contamination has not yet been sufficiently reduced via the known methods of antimicrobial modification.

It was an object of the present invention to provide an antimicrobially modified plastic, and in particular to provide medical items comprising such a plastic. Examples of representative medical items include catheters. Medical items and plastics of the present invention advantageously sufficiently inhibit surface contamination or colonization by microbes over a prolonged period, and preferably release less than about 5% of initial amount of active ingredient over a period of 15 days.

It has now been found that these and other objectives can be achieved for example, by using a plastic compositions comprising a thermoplastic elastomer and at least one active ingredient selected from the group of bis(4-(substituted amino)-1-pyridinium)alkanes.

Additional objects, features and advantages of the invention will be set forth in the description which follows, and in part, will be obvious from the description, or may be learned by practice of the invention. The objects, features and advantages of the invention may be realized and obtained by means of the instrumentalities and combination particularly pointed out in the appended claims.

### BRIEF DESCRIPTION OF THE DRAWINGS

The accompanying drawings, which are incorporated in and constitute a part of the specification, illustrate a presently preferred embodiment of the invention, and, together with the general description given above and the detailed description of the preferred embodiment given below, serve to explain the principles of the invention.

FIG. 1 is a schematic of an experimental apparatus for the dynamic model of Example 8.

### DETAILED DESCRIPTION OF A PREFERRED EMBODIMENT

Preferably concentration of active ingredient which is sufficient to suppress, or at least significantly reduce, colonization by undesired microbes over a prolonged period. This prolonged period is preferably at least 2 weeks, particularly preferably more than 4 weeks. Undesired microbes means respectively bacteria, viruses and fungi, and other such pathogens.

The present invention also provides moldings comprising an inventive plastics composition. Examples of these moldings include, for example, catheters, hoses, foils, connectors, fibers and non-wovens.

The present invention further provides a method for the preparation of the inventive plastics composition. Plastic compositions of the present invention are preferably prepared via thermoplastic processing and optionally further processed if desired.

This present invention is further directed to the use of the inventive plastic composition for catheters, hoses, foils, connectors, fibers and non-wovens.

Active ingredients that can be used are in principle any suitable material such as active ingredients defined in Patent Claims 1 to 4 on p. 28 of DE 27 08 331 C2 which is incorporated herein by reference. It is preferable to use the compounds from Examples 1-82 (p. 5 to p. 18, line 19 incorporated herein by reference), and it is particularly preferable to use octenidine or its hydrochloride, or very particularly preferably the dihydrochloride 1,1′-(1,10-decanediyl)bis[4-(octylamino)pyridinium] dichloride.

These active ingredients termed bis(4-(substituted amino)-1-pyridinium)alkanes are defined via formulae (I) and (II) 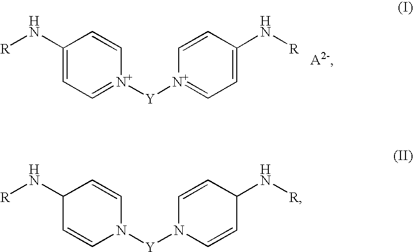
where
Y can be independently in each instance an alkylene group having from 4 to 18 carbon atoms,
R can be independently in each instance C₆-C₁₈-alkyl, C₅-C₇-cycloalkyl or halogen-atom-substituted phenyl and
A can be independently in each instance two monovalent anions or one divalent anion.
Y can be preferably 1,10-decylene or 1,12-dodecylene, particularly preferably 1,12-dodecylene.
R can be preferably n-hexyl, n-heptyl or n-octyl, particularly preferably n-octyl.
A can be, for example a sulfate, or in each case 2 fluoride, chloride, bromide, iodide, or methanesulphonate ions, preferably in each case 2 fluoride, chloride, or bromide ions, particularly preferably 2 chloride ions.

In formula (II), the corresponding free bases which can be prepared via neutralization from the salts of the formula (I) by the conventional methods of organic chemistry. The salts of the formula (I) can also be in the form of the formula (III)
formula (II)×H₂A (III),
where “formula (II)” and A are defined as stated above. A chemical formula is naturally only a simplified representation of reality. In this case there are tautomers for which there is no indication that they are distinguishable under commonly encountered conditions and temperatures. Nevertheless, for octenidine dihydrochloride there are presently 2 Chemical Abstracts Registry numbers and 2 numbers in the European list of approved substances. For the present invention, it is to be of no relevance whether compounds of the formula (I) in some cases or of the formula (III) are used, or which form these take in the polymer composition. It is preferable to use salts of the formula (I) or (III).

Particularly suitable materials include thermoplastic elastomers (TPE). TPEs are materials which comprise elastomeric phases physically incorporated by mixing into thermoplastically processable polymers or incorporated therein by chemical bonding. A distinction is made between polymer blends, in which the elastomeric phases present have been incorporated by physical mixing, and block copolymers, in which the elastomeric phases are a constituent of the polymeric structure itself. By virtue of the structure of the thermoplastic elastomers, there are hard and soft regions present alongside one another. The hard regions form a crystalline network structure or a continuous phase whose interstices have been filled by elastomeric segments. By virtue of this structure, these materials have rubber-like properties.

Three main groups of thermoplastic elastomers can be distinguished:
1. copolyesters
2. polyether block amides (PEBA)
3. thermoplastic polyurethanes (TPU)

DE-A 22 39 271, DE-A 22 13 128, DE-A 24 49 343 and U.S. Pat. No. 3,023,192 each incorporated herein by reference, disclose processes for synthesis of copolyesters of this type. For the purposes of the present invention, examples of suitable copolyesters include those based on terephthalic acid with certain proportions of isophthalic acid, or else butanediol and polyethers, preferably C₄ polyethers, based on tetrahydofuran and, by way of example, obtainable with trademark Hytrel™ from Du Pont, Pelpren™ from Toyobo, Arnitel™ from Akzo or Ectel™ from Eastman Kodak.

French Patent 7 418 913 (publication No. 2 273 021), DE-A 28 02 989, DE-A 28 37 687, DE-A 25 23 991, EP 0 095 893 B2, DE-A 27 12 987 and DE-A 27 16 004 (all incorporated herein by reference) disclose processes for synthesis of the PEBA polymers. According to the present invention, particularly suitable PEBA polymers include those which unlike those described above, have generally a random structure. Examples of units include adipic acid, aminododecanoic acid, a proportion of hexamethylenediamine, polytetrahydrofuran, and a proportion of polyethylene glycol.

Suitable thermoplastically processable polyurethanes that can be used according to the invention are obtainable for example, via a reaction of the following polyurethane-forming components:
A) organic diisocyanate,
B) linear hydroxy-terminated polyol whose number average molecular weight Mn is from 500 to 10 000,
C) chain extender whose number average molecular weight Mn is from 60 to 500,
   where the molar ratio of the NCO groups in A) to the groups reactive towards isocyanate in B) and C) is preferably from 0.9 to 1.2.

Examples of organic diisocyanates A) that can be used include aliphatic, cycloaliphatic, heterocyclic and aromatic diisocyanates, such as those described in Justus Liebigs Annalen der Chemie, 562, pp. 75-136 (incorporated herein by reference). Aliphatic and cycloaliphatic diisocyanates are preferred.

Individual compounds which may be mentioned by way of example include, for example: aliphatic diisocyanates, such as hexamethylene diisocyanate, cycloaliphatic diisocyanates, such as isophorone diisocyanate, cyclohexane 1,4-diisocyanate, 1-methylcyclohexane 2,4-diisocyanate and 1-methylcyclohexane 2,6-diisocyanate, and also the corresponding isomer mixtures, dicyclohexylmethane 4,4′-diisocyanate, dicyclohexylmethane 2,4′-diisocyanate and dicyclohexylmethane 2,2′-diisocyanate, and also the corresponding isomer mixtures, aromatic diisocyanates, such as tolylene 2,4-diisocyanate, mixtures composed of tolylene 2,4-diisocyanate and tolylene 2,6-diisocyanate, diphenylmethane 4,4′-diisocyanate, diphenylmethane 2,4′-diisocyanate and diphenylmethane 2,2′-diisocyanate, mixtures comprising diphenylmethane 2,4′-diisocyanate and diphenylmethane 4,4′-diisocyanate, urethane-modified liquid diphenylmethane 4,4′-diisocyanate and diphenylmethane 2,4′-diisocyanate, 4,4′-diisocyanato-(1,2)-diphenylethane and naphthylene 1,5-diisocyanate. It is preferable in some cases to use hexamethylene 1,6-diisocyanate, isophorone diisocyanate, dicyclohexylmethane diisocyanate, diphenylmethane diisocyanate isomer mixtures preferably with >about 96% by weight content of diphenylmethane 4,4′-diisocyanate, and in particular diphenylmethane 4,4′-diisocyanate and naphthylene 1,5-diisocyanate. The diisocyanates mentioned may be used individually or in the form of mixtures with one another. They can also be used together with up to about 15% by weight (based on the total amount of diisocyanate) of a polyisocyanate, for example with triphenylmethane 4,4′,4″-triisocyanate or with polyphenyl polymethylene polyisocyanates.

The component B) used generally comprises a linear hydroxy-terminated polyol whose average molecular weight Mn is preferably from 500 to 10,000, more preferably from 500 to 5000, particularly preferably from 600 to 2000. As a consequence of the production process, these polyols can often comprise small amounts of branched compounds. A term often used is therefore “substantially linear polyols”. Preference is preferably given to polyetherdiols, polycarbonatediols, sterically hindered polyesterdiols, hydroxy-terminated polybutadienes, and mixtures of these.

Other soft segments that can be used comprise polysiloxanediols of the formula (IV)
HO—(CH₂)ₙ—[Si(R¹)₂—O—]ₘSi(R¹)₂—(CH₂)ₙ—OH (IV)
where
R¹ independently from each other in each case is an alkyl group having from 1 to 6 carbon atoms or a phenyl group,
m independently from each other in each case is from 1 to 30, preferably from 10 to 25 and particularly preferably from 15 to 25, and
n independently from each other in each case is from 3 to 6,
   and these can be used alone or in a mixture with the abovementioned diols. These are known products and can be prepared, for example by synthesis methods known per se, for example via reaction of a silane of the formula (V)
   H—[Si(R¹)₂—O—]ₘSi(R¹)₂—H (V)
   where R¹ and m are as defined above,
   in a ratio of 1:2 with an unsaturated, aliphatic or cycloaliphatic alcohol, e.g. allyl alcohol, buten-(1)-ol or penten-(1)-ol in the presence of a catalyst, e.g. hexachloroplatinic acid.

Suitable polyetherdiols can be prepared, for example, by reacting one or more alkylene oxides having from 2 to 4 carbon atoms in the alkylene radical with a starter molecule which contains two active hydrogen atoms. Examples of alkylene oxides that may be mentioned include:

ethylene oxide, propylene 1,2-oxide, epichlorohydrin and butylene 1,2-oxide and butylene 2,3-oxide. It is preferable to use ethylene oxide, propylene oxide and/or mixtures comprising propylene 1,2-oxide and ethylene oxide. The alkylene oxides can be used individually, in alternating succession, and/or in the form of mixtures. Examples of starter molecules that can be used include: water, amino alcohols, such as N-alkyldiethanolamines, e.g. N-methyldiethanolamine, and diols, such as ethylene glycol, propylene 1,3-glycol, 1,4-butanediol and 1,6-hexanediol. Mixtures of starter molecules can also be used, if appropriate. Other suitable polyetherdiols include tetrahydrofuran-polymerization products containing hydroxy groups. It is also possible to use proportions of from 0 to about 30% by weight, based on the bifunctional polyethers, of trifunctional polyethers, their amount being, however, preferably not more than that giving a thermoplastically processable product. The substantially linear polyetherdiols can be used either individually or else in the form of mixtures with one another.

Examples of suitable sterically hindered polyesterdiols can be prepared for example from dicarboxylic acids having preferably from 2 to 12 carbon atoms, more preferably from 4 to 6 carbon atoms, and from polyhydric alcohols. Examples of dicarboxylic acids that can be used include aliphatic dicarboxylic acids, such as succinic acid, glutaric acid, adipic acid, suberic acid, azelaic acid and sebacic acid and aromatic dicarboxylic acids, such as phthalic acid, isophthalic acid and terephthalic acid. The dicarboxylic acids can be used individually or in the form of mixtures, e.g. in the form of a mixture of succinic, glutaric and/or adipic acid. To prepare the polyester diols it can, if appropriate, be advantageous to use, instead of the dicarboxylic acids, the corresponding dicarboxylic acid derivatives, such as dicarboxylic esters preferably having from 1 to 4 carbon atoms in the alcohol radical, carboxylic anhydrides, or carbonyl chlorides. Examples of polyhydric alcohols include sterically hindered glycols preferably having from 2 to 10, more preferably from 2 to 6, carbon atoms, and typically bearing at least one alkyl radical in the beta position with respect to the hydroxy group, examples including 2,2-dimethyl-1,3-propanediol, 2-methyl-2-propyl-1,3-propanediol, 2,2-diethyl-1,3-propanediol, 2-ethyl-1,3-hexanediol, 2,5-dimethyl-2,5-hexanediol, 2,2,4-trimethyl-1,3-pentanediol, or mixtures with ethylene glycol, diethylene glycol, 1,4-butanediol, 1,5-pentanediol, 1,6-hexanediol, 1,10-decanediol, 1,3-propanediol and dipropylene glycol. Depending on the properties desired or required, the polyhydric alcohols can be used alone or, if appropriate, in a mixture with at least one other alcohol. Other suitable compounds include esters of carbonic acid with the diols mentioned, in particular those having preferably from 3 to 6 carbon atoms, examples including 2,2-dimethyl-1,3-propanediol or 1,6-hexanediol, condensates of hydroxycarboxylic acids, such as hydroxycaproic acid, and polymerization products of lactones, for example of unsubstituted and/or substituted caprolactones. Polyesterdiols preferably used include neopentyl glycol polyadipates and 1,6-hexanediol neopentyl glycol polyadipates. The polyesterdiols can be used individually or in the form of a mixture with at least one other polyesterdiol.

If appropriate, other polyols can be used alongside polyesterdiols, examples include polycarbonatediols, polyetherdiols, and/or mixtures thereof.

Polycarbonates which have hydroxy groups and which can be used include those of the type known per se, by way of example, as being capable of preparation via reaction of diols, such as (1,3)-propanediol, (1,4)-butanediol and/or (1,6)-hexanediol, diethylene glycol, triethylene glycol, tetraethylene glycol or thiodiglycol with diaryl carbonates, e.g. diphenyl carbonate or phosgene (DE-B 16 94 080, DE-A 22 21 751, both of which are incorporated herein by reference).

In addition to polyester polyols and the polycarbonate diols, it is also possible to use mixtures comprising polyether polyols, and/or polyester polyols, and/or mixtures comprising polyether polyols and/or polycarbonatediols, each with a number-average molar mass of preferably from about 600 to about 5000 g/mol, preferably from 700 to 4200 g/mol.

Chain extenders C) used preferably comprise diols, diamines and/or aminoalcohols whose Mn molecular weight is from 60 to 500, preferably aliphatic diols having from 2 to 14 carbon atoms, e.g. ethanediol, 1,6-hexanediol, diethylene glycol, dipropylene glycol, and in particular 1,4-butanediol. However, other suitable compounds include diesters of terephthalic acid with glycols preferably having from 2 to 4 carbon atoms, e.g. bis(ethylene glycol) terephthalate or bis(1,4-butanediol) terephthalate, hydroxyalkylene ethers of hydroquinone, e.g. 1,4-di(hydroxyethyl)hydroquinone, ethoxylated bisphenols, (cyclo)aliphatic diamines, e.g. isophoronediamine, ethylenediamine, 1,2-propylenediamine, 1,3-propylenediamine, N-methyl-1,3-propylenediamine, 1,6-hexamethylenediamine, 1,4-diaminocyclohexane, 1,3-diaminocyclohexane, N,N′-dimethylethylenediamine and 4,4′-dicyclohexyl-methanediamine and aromatic diamines, e.g. 2,4-tolylenediamine and 2,6-tolylenediamine, 3,5-diethyl-2,4-tolylenediamine and 3,5-diethyl-2,6-tolylenediamine and primary mono-, di-, tri- or tetraalkyl-substituted 4,4′-diaminodiphenylmethanes or aminoalcohols, such as ethanolamine, 1-aminopropanol, 2-aminopropanol. It is also possible to use mixtures of the abovementioned chain extenders. In addition, it is also possible to use relatively small amounts preferably of crosslinking agents of functionality three or greater, for example glycerol, trimethylolpropane, pentaerythritol, sorbitol. It is particularly preferable to use 1,4-butanediol, 1,6-hexanediol, isophoronediamine and/or mixtures of these.

It is also possible to use very small amounts of conventional monofunctional compounds, for example, as chain terminators or mold-release agents. By way of example, mention may be made of alcohols, such as octanol and stearyl alcohol, or amines, such as butylamine and stearylamine.

The molar ratios of the structural components can be varied over a wide range, thus permitting adjustment of the properties of the product. Molar ratios of polyols to chain extenders of advantageously from 1:1 to 1:12 have proven successful. The molar ratio of diisocyanates and polyols is preferably from 1.2:1 to 30:1. Ratios of from 2:1 to 12:1 are particularly preferred. To prepare the TPUs, the amounts of the structural components reacted, if appropriate in the presence of catalysts, of auxiliaries and of additives, can be such that the ratio of equivalents of NCO groups to the total of the NCO-reactive groups, in particular of the hydroxy or amino groups of the lower-molecular-weight diols/triols, and amines and of the polyols is preferably from 0.9:1 to 1.2:1, more preferably from 0.98:1 to 1.05:1, particularly preferably from 1.005:1 to 1.01:1.

Suitable polyurethanes that can be used according to the present invention can be prepared without catalysts; in some cases, however, it can be advisable to use catalysts. The amounts generally used of the catalyst can be, for example up to 100 ppm, based on the total amount of starting materials to form the polyurethane. Suitable catalysts according to the present invention include conventional tertiary amines known from the prior art, e.g. triethylamine, dimethylcyclohexylamine, N-methylmorpholine, N,N′-dimethylpiperazine, 2-(dimethylaminoethoxy)ethanol, diazabicyclo[2.2.2]octane and the like, and also in particular organometallic compounds, such as titanic esters, iron compounds, tin compounds, e.g. stannous diacetate, stannous dioctoate, stannous dilaurate or the dialkyltin salts of aliphatic carboxylic acids. Dibutyltin diacetate and dibutyltin dilaurate are preferred. Amounts of from 1 to 10 ppm of these are typically sufficient to catalyse the reaction if needed for any reason.

Alongside the TPU components and the catalysts, it is also possible to add any other auxiliaries and additives as desired. By way of example, mention may be made of lubricants, such as fatty acid esters, metal soaps of these, fatty acid amides and silicone compounds, anti-blocking agents, inhibitors, stabilizers with respect to hydrolysis, light, heat and discoloration, flame retardants, dyes, pigments, inorganic or organic fillers and reinforcing agents. Reinforcing agents include, in particular fibrous reinforcing agents, such as inorganic fibers, which can be produced according to known methods and can also have been sized. Further details concerning the auxiliaries and additives mentioned are found in the technical literature, for example J. H. Saunders, K. C. Frisch: “High Polymers”, Volume XVI, Polyurethane [Polyurethanes], Part 1 and 2, Interscience Publishers 1962 and 1964, R. Gächter, H. Müller (Ed.): Taschenbuch der Kunststoff-Additive [Plastics additives], 3rd Edition, Hanser Verlag, Munich 1989, or DE-A 29 01 774, all of which are incorporated herein by reference.

Thermoplastically processable polyurethane elastomers are preferably constructed by what is known as a prepolymer process. In a prepolymer process, an isocyanate-containing prepolymer is formed from the polyol and from the diisocyanate, and is then reacted with the chain extender. The TPUs can be prepared in any way including continuously and/or batchwise. Well known industrial preparation processes include the belt process and the extruder process.

The inventive moldings can be produced for example via extrusion of a melt comprising the polymer and active ingredient. The melt can preferably comprise from 0.01 to 10% by weight, more preferably from 0.1 to 5% by weight, of active ingredient. The components may be mixed by any technique in any manner. By way of example, the active ingredient can be introduced for example, directly in solid form into the polymer melt. Alternatively or in addition, another method mixes a masterbatch comprising active ingredient directly with the polymer and/or with the polymer melt previously prepared. Another method applies the active ingredient by any technique to the polymer, even before melting of the polymer (via tumbling, spray-application, etc.). Other possible methods include mixing/homogenizing of the components by known techniques such as by way of kneaders or screw machines, preferably in single- or twin-screw extruders in the temperature range preferably from 150 to 200° C. Mixing of the components during the extrusion process generally is capable of achieving homogeneous dispersion of the active ingredient at the molecular level within the polymer matrix, without any need for additional operations.

The examples below are intended to illustrate, but not restrict, the invention.

### EXAMPLES

### Example 1 (comparative example)

Commercially available aromatic polyetherurethane with 20% by weight of barium sulfate Tecothane™ TT 2085 A-B20 of Shore hardness 85 A (Noveon, Woburn Mass.)

The cylindrical pellets comprising no active ingredients were extruded in a ZSK twin-screw extruder. This gave a clear melt which, after cooling in a water/air bath and strand pelletization, gave colorless, clear cylindrical pellets.

For microbiological in-vitro studies in the dynamic test model, and also for determination of the release profile of the incorporated active ingredient, extrudate specimens (diameter 2 mm and length about 17 cm) were taken, and the pellets were injection-molded to give test specimens (sheets).

Plaques of diameter 5 mm were cut out from the sheets. Sheets and extrudate specimens were sterilized with 25 kGr of gamma radiation.

### Example 2

5 g of octenidine dihydrochloride was applied to 995 g of Tecothane™ TT2085A-B20 comprising no active ingredient, in an intensive mixer. The cylindrical pellets comprising active ingredient were extruded in a ZSK twin-screw extruder. This gave a clear melt which, after cooling in a water/air bath and strand pelletization, gave colorless, clear cylindrical pellets.

For microbiological in-vitro studies in the dynamic test model, and also for determination of the release profile of the incorporated active ingredient, extrudate specimens (diameter 2 mm and length about 17 cm) were taken, and the pellets were injection-molded to give test specimens (sheets).

Plaques of diameter 5 mm were cut out from the sheets. Sheets and extrudate specimens were sterilized with 25 kGr of gamma radiation.

### Example 3

10 g of octenidine dihydrochloride was applied to 990 g of Tecothane™ TT2085A-B20 comprising no active ingredient, in an intensive mixer. The cylindrical pellets comprising active ingredient were extruded in a ZSK twin-screw extruder. This gave a clear melt which, after cooling in a water/air bath and strand pelletization, gave colorless, clear cylindrical pellets.

For microbiological in-vitro studies in the dynamic test model, and also for determination of the release profile of the incorporated active ingredient, extrudate specimens (diameter 2 mm and length about 17 cm) were taken, and the pellets were injection-molded to give test specimens (sheets).

Plaques of diameter 5 mm were cut out from the sheets. Sheets and extrudate specimens were sterilized with 25 kGr of gamma radiation.

### Example 4

15 of octenidine dihydrochloride was applied to 985 g of Tecothane TT2085A-B20 comprising no active ingredient, in an intensive mixer. The cylindrical pellets comprising active ingredient were extruded in a ZSK twin-screw extruder. This gave a clear melt which, after cooling in a water/air bath and strand pelletization, gave colorless, clear cylindrical pellets.

For microbiological in-vitro studies in the dynamic test model, and also for determination of the release profile of the incorporated active ingredient, extrudate specimens (diameter 2 mm and length about 17 cm) were taken, and the pellets were injection-molded to give test specimens (sheets).

Plaques of diameter 5 mm were cut out from the sheets. Sheets and extrudate specimens were sterilized with 25 kGr of gamma radiation.

### Example 5 (comparative example)

Commercially available catheter modified antimicrobially with fine-particle metallic silver, platinum and carbon.

### Example 6

Chronoflex AL 85A-B20 was milled at −40° C. to give a powder, which was then sieved to give two fractions: first fraction from 100 μm to 300 μm; second fraction >300 μm.

### Example 7

400 g of octenidine dihydrochloride was mixed in an intensive mixer with 3600 g of Chronoflex AL 85A-B20 powder (from 100 to 300 μm) from Example 6 comprising no active ingredient. 16 kg of Chronoflex AL 85A-B20 pellets and 4000 g of the polymer/active ingredient powder mixture were fed into barrel section 1 of the extruder, throughput of the extruder being 3 kg/hour. The cylindrical pellets comprising active ingredient were extruded in a Brabender ZSK twin-screw extruder. This gave a white melt which, after cooling in a water/air bath and strand pelletization, gave white cylindrical pellets with 2% by weight of octenidine dihydrochloride.

For determination of the release profile of the incorporated active ingredient, the pellets were injection-molded to give test specimens (sheets).

### Example 8

The following structure was selected for experiments to check activity:

### Dynamic Model For Demonstrating Antimicrobial Activity of Materials

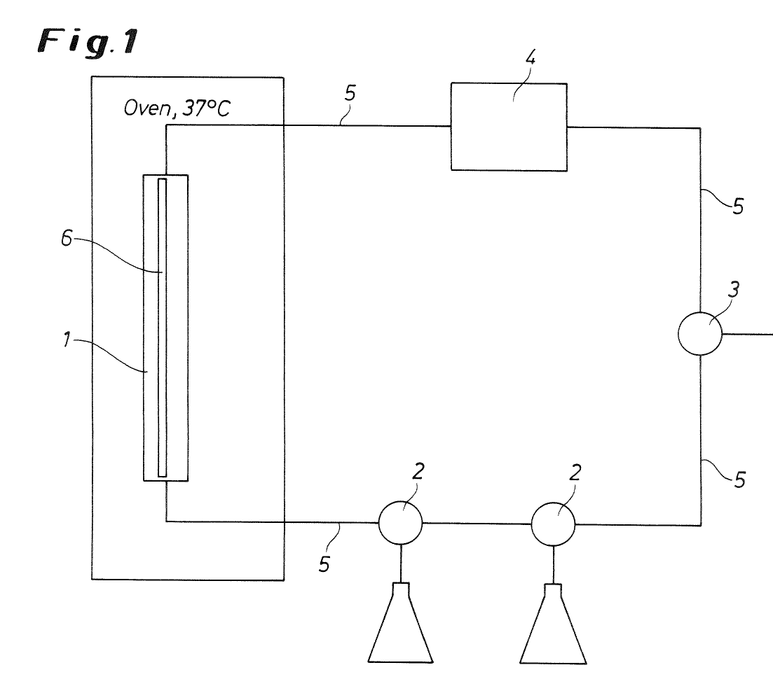

The model presented was intended to demonstrate the antimicrobial activity of materials and to demonstrate inhibition of biofilm formation on the materials. The experimental apparatus is composed of the following components (cf. also FIG. 1):

| | |
|---|---|
| 1. | Reaction chamber |
| 2. | System for exchanging nutrient media (2 coupled three-way valves) |
| 3. | Sampling chamber |
| 4. | Peristaltic pump |
| 5. | Tubing system |
| 6. | Specimen |

A piece of extrudate of the specimen to be studied was introduced into a reaction chamber and firmly fixed at both sides by means of shrinkable tubing. The location of the reaction chamber during the test time is within the incubator.

The tubing system leads onwards to the exchange system for nutrient media. Using one three-way valve, with outlet setting, nutrient medium can be pumped out of the circuit, and using the second three-way valve, with inlet setting, nutrient medium can be introduced into the circuit.

The tubing system leads onward by way of the sampling chamber to the specimen-removal system for determination of number of microbes and addition of the bacterial suspension, and then by way of the peristaltic pump back to the reaction chamber.

### I1. Method

The dynamic biofilm model was used for the studies of the antimicrobial activity of sample specimens (sample tubing) and catheters over an extended period.

1.1. Test Sheets

Mueller-Hinton™ agar plates were used for the culture mixtures for determination of microbe numbers. For this purpose, 18 ml of Mueller-Hinton™ agar (Merck KGaA Darmstadt/Batch VM132437 339) are poured into Petri dishes of diameter 9 cm.

1.2. Medium

Mueller-Hinton™ bouillon (Merck KGaA Darmstadt/Batch VM205593 347) was used as medium for the dynamic biofilm model.

1.3. Bacterial Suspension

The test strain was added in the form of suspension in the dynamic biofilm model. A suspension with density corresponding to McFarland 0.5 in NaCl solution at 0.85% strength was prepared from an overnight culture of test strain on Columbia blood agar. A “colony pool” composed of from 3 to 4 colonies applied by spotting with an inoculation loop was used for the suspension. The suspension was diluted twice in a ratio of 1:100. This dilution was used for charging to the model.

1.4. Test Mixture

Each separate model circuit (reaction chamber+tubing system) was charged with about 16 ml of medium from its associated supply flask (medium 1.2). 100 μl of the bacterial suspension (1.3) were then added by way of the sampling chamber to the model circuit, using a pipette. In parallel with this, 100 μl of the bacterial suspension were plated out for determination of microbe numbers (1.1).

The average number of microbes present in the model circuit after each addition of the bacterial suspension was at least 200 CPU/ml.

The peristaltic pump was set at a speed of 5 rpm (revolutions per minute), the resultant amount conveyed in the tubing used in the experiment being 0.47 ml/min.

A result was that the content of a model circuit was exchanged and, respectively, passed over the catheter once in the reaction chamber over the course of a half hour.

4 ml (25% of the entire liquid) was removed from the model circuit for the first time after 24 hours and then daily or at varying intervals, and replaced by fresh medium.

The bacterial concentration in each separate model circuit was determined in the specimens removed. 50 μl from the specimen were streaked by an inoculation loop onto a test plate and incubated at 37° C. for 24 hours. The number of microbes was estimated from the growth within the smear, or 50 μl were inoculated with a pipette onto a test plate, and distributed by using a spatula, and incubated at 37° C. for 24 hours, and the calculation was based on colony counting.

In addition to media exchange, 100 μl of the bacterial suspension was added with a pipette to the model circuit daily or in varying intervals by way of the sampling chamber. The number of microbes in the bacterial suspension added varied from 1800 to 15,000 bacteria per ml. Addition of a constant, always identical amount of bacteria was intentionally avoided, since in practice it also has to be expected that there will be varying numbers of pathogens that could come into contact with the catheter.

At the end of the experimental time, namely, after 30 days, the catheters and extrudate specimens to be studied were removed from the reaction vessel, and in each case cut into three pieces of length 2 cm, which were treated as follows:
MAKI Test: Each catheter section is rolled back and forth four times on a Columbia blood agar plate.
VORTEX Test: The respective catheter section is washed three times in 3 ml of distilled water in a Vortex shaker at 3000 rpm (IKA™ Minishaker). Three times 50 μl of the wash solution are streaked using an inoculation loop onto a Columbia blood agar plate.
ULTRASOUND Test: The respective catheter section is sonicated and washed in 3 ml of distilled water for 10 min in an ultrasound bath. Three times 50 μl of the wash solution are streaked using an inoculation loop onto a Columbia blood agar plate.

### 2. Material

2.1. Material Specimens

The extrudate specimens provided for study from comparative Example 1, and from inventive Examples 2-4 and from comparative Example 5 were tested.

| | |
|---|---|
| Comparative Example 1 | Extrudate specimen |
| Example 2 | Extrudate specimen |
| Example 3 | Extrudate specimen |
| Example 4 | Extrudate specimen |
| Comparative Example 5 | Piece of catheter |

2.2. Test Strains

A Staphylococcus epidermidis strain ATCC 35984 designated for Biofilm formation was used as test strain for the dynamic biofilm model. The strain was provided by the Medical College of Hanover.

### 3. Evaluation

3.1 Biofilm Formation

In the case of 2 tubing samples [Example 1 and Example 6 (both comparative examples)], bacterial colonization, i.e. a biofilm, was observed, but in the case of the other tubing samples there was no detectable bacterial growth in the reaction medium, no detectable colonization and no detectable biofilm.

3.2 Discussion of Results

The dynamic biofilm model permits demonstration of biofilm formation or demonstration of inhibition of biofilm formation via the antimicrobial action of a material or of a finished catheter.

The experimental arrangement permits approximation to the natural situation of the catheter within the skin.

Approximate simulation of the following factors is possible:
The medium comprises all of the factors for bacterial growth, corresponding to skin tissue fluid.
The active ingredient can be released slowly from the catheter into the environment and develop antimicrobial activity there or directly on the catheter.
The amount of bacteria introduced is variable, and can be adjusted to the level of the amounts occurring naturally or to the level of an infection dose.

Exclusively in the case of the extrudate specimen from comparative Example 1, various high numbers of microbes were demonstrated in the reaction chamber medium over the entire investigation time of 30 days. In the case of the catheter from comparative Example 5, bacteria were always detectable from the 7th day of the experiment. In the case of both specimens for Ex. 1 and 5, it was also possible to detect a biofilm.

In the case of the extrudate specimens from inventive Examples 2 to 4, with a few exceptions, no bacteria could be detected in the reaction chamber medium over the entire investigation time of 30 days.

In the case of the extrudate specimens from inventive Examples 2 to 4, after addition of a high bacterial concentration on the 28th day of the experiment, bacteria at a concentration of 102 per CFU per ml were found in the reaction chamber medium on the 29th day of the experiment. Nevertheless, on the next day, the 30th day of the experiment, no bacteria were then detectable, and there was also no detectable adhesion to the sample tubing and also no detectable biofilm.

### Example 9

### Agar Diffusion Test

### 1. Method

The agar diffusion test was used to study antimicrobial action.

1.1. Test Plates

18 ml of NCCLS Mueller-Hinton™ agar (Merck KGaA Darmstadt/Batch ZC217935 430) were poured into Petri dishes of diameter 9 cm.

1.2. Bacterial Suspension

A suspension with density corresponding to McFarland 0.5 in NaCl solution at 0.85% strength was prepared from an overnight culture of test strain on Columbia blood agar. A “colony pool” composed of from 3 to 4 colonies applied by spotting with an inoculation loop was used for the suspension.

1.3. Test Mixture

A sterile cotton-wool pad is dipped into the suspension. The excess liquid is spilled under pressure on the glass edge. Using the pad, the Mueller-Hinton™ agar plate is uniformly inoculated in three directions, the angle between each being 60°. Material plaques and test plaques are then placed on the test plate. The test plates were incubated at 37° C. for 24 hours.

The antimicrobial action of the specimens was assessed on the basis of zones of inhibition.

Comparison with the studies in the agar diffusion test, by testing all of the specimens for their antimicrobial action, shows that the specimens revealing hardly any, or no antimicrobial action in this study likewise exhibit no antimicrobial action and are attended by severe biofilm (cf. Table 1).

TABLE 1
Microbiological activity in the agar diffusion test with respect to various microbes

| | Test strain | | | | | | |
|---|---|---|---|---|---|---|---|
| | E. coli | P. mirabilis | P. aeruginosa | S. aureus | MRSA | C. albicans | |
| Material | 35218 | 35695 | 27853 | 29213 | 0134-93 | 14053 | Biofilm |
| Comparative | − | − | − | − | − | − | + |
| Example 1 | | | | | | | |
| Example 2 | + | + | + | + | + | + | − |
| Example 3 | + | + | + | + | + | + | − |
| Example 4 | + | + | + | + | + | + | − |
| Comparative | − | − | − | − | − | − | + |
| Example 5 | | | | | | | |

− No activity (final column: no biofilm formation)
+ Activity (final column: biofilm formation)

The specimens from inventive Examples 2 to 4 also have the capability of inhibiting not only colonization by gram-negative and gram-positive bacteria, but also colonization by yeasts.

### Example 10

The elution experiments were carried out on injection-molded sheets which had been cut into pieces of size 1 cm². Each of the specimens weighed about 2.2 g and had surface area of 20.5 cm². 16 ml of demineralized water was used as eluent. After each of 1 h, 4 h, 8 h, 24 h, 48 h, 120 h and 360 hours (15 days), the aqueous eluent was replaced by fresh eluent and the active ingredient content in the solutions was determined.

TABLE 2
Eluted amount of active ingredient, based
on the amount initially present

| Hours | Example 2 | Example 3 | Example 4 | Example 7 |
|---|---|---|---|---|
| 1 | 0.089% | 0.227% | 0.100% | 0.023% |
| 4 | 0.207% | 0.459% | 0.310% | 0.025% |
| 12 | 0.326% | 0.615% | 0.506% | 0.027% |
| 24 | 0.622% | 1.067% | 0.972% | 0.029% |
| 48 | 1.096% | 1.600% | 1.497% | 0.031% |
| 120 | 2.296% | 3.059% | 2.980% | 0.039% |
| 360 | 5.200% | 6.711% | 6.340% | 0.108% |

Taking the total across all 7 of these solutions, the amount extracted of the initial amount of active ingredient was 5.200% from the plaques of Example 2, 6.711% from the plaques of Example 3, 6.34% from the plaques of Example 4, and only 0.108% from the plaques of Example 7. Thus the amount of active ingredient remained in an amount from 93.3%-99.8% over 360 hours.

FIG. 1 shows components of experimental apparatus for the dynamic model of Example 8 with specimen as set forth below:

| | |
|---|---|
| 1 | Reaction chamber |
| 2 | System for exchanging nutrient media (2 coupled three-way valves) |
| 3 | Sampling chamber |
| 4 | Peristaltic pump |
| 5 | Tubing system |
| 6 | Specimen |

Additional advantages, features and modifications will readily occur to those skilled in the art. Therefore, the invention in its broader aspects is not limited to the specific details, and representative devices, shown and described herein. Accordingly, various modifications may be made without departing from the spirit or scope of the general inventive concept as defined by the appended claims and their equivalents.

As used herein and in the following claims, articles such as “the”, “a” and “an” can connote the singular or plural.

In the present description and in the following claims, to the extent a numerical value is enumerated, such value is intended to refer to the exact value and values close to that value that would amount to an insubstantial change from the listed value

All documents and standards referred to herein are expressly incorporated herein by reference in their entireties.

What is claimed is:

1. A composition comprising a thermoplastic elastomer and at least one active ingredient selected from the group consisting of bis(4-(substituted amino)-1-pyridinium)alkanes.

2. A composition according to claim 1, wherein the thermoplastic elastomer is selected from the group consisting of copolyester, polyether block amides and thermoplastic polyurethanes.

3. A composition according to claim 1, wherein the active ingredient is selected from the group consisting of compounds of substances of formulae (I) and (II) 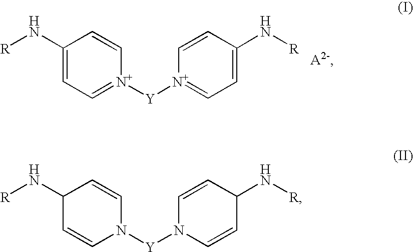
where
Y independent in each case is an alkylene group having from 4 to 18 carbon atoms,
R independent in each case is C₆-C₁₈-alkyl, C₅-C₇-cycloalkyl or halogen-atom-substituted phenyl and
A independent in each case is two monovalent anions or a divalent anion.

4. A composition according to claim 1, wherein the concentration of the active ingredient in said composition is sufficient to suppress or significantly reduce, over a prolonged period, colonization by undesired microbes.

5. A composition according to claim 1, wherein the concentration of the active ingredient is from 0.01 to 5 percent by weight, based on the weight of active ingredient and thermoplastic elastomer.

6. A composition according to claim 1, comprising thermoplastic polyurethane and octenidine dihydrochloride.

7. A process for preparing of a plastics according to claim 1, comprising extruding a melt comprising said active ingredient and said thermoplastic elastomer.

8. A molding comprising a composition according to claim 1.

9. A composition of claim 4, wherein said prolonged period is at best about two weeks, and said undesired microbes comprise bacteria, viruses and/or fungi.

10. A composition of claim 1, wherein said active ingredient remains in said composition at an amount of from 93.3%-99.8% over 360 hours.

11. A composition of claim 1, wherein said composition does not produce a biofilm when exposed to bacteria, viruses and/or fungi.

12. A composition of claim 6, wherein said active ingredient remains in said composition at an amount of from 93.3%-99.8% over 360 hours.

13. A composition of claim 6, wherein said composition does not produce a biofilm when exposed to bacteria, viruses and/or fungi.

14. A composition according to claim 2, wherein the concentration of the active ingredient in said composition is sufficient to suppress or significantly reduce, over a prolonged period, colonization by undesired microbes.

15. A composition of claim 2, wherein said prolonged period is at best about two weeks, and said undesired microbes comprise bacteria, viruses and/or fungi.

16. A composition of claim 3, wherein said prolonged period is at best about two weeks, and said undesired microbes comprise bacteria, viruses and/or fungi.

17. A composition of claim 6, wherein said prolonged period is at best about two weeks, and said undesired microbes comprise bacteria, viruses and/or fungi.

18. A process for preparing of a plastics according to claim 6, comprising extruding a melt comprising said active ingredient and thermoplastic elastomer.

19. A medical product comprising a composition of claim 6.

20. A medical product of claim 19 comprising a catheter hose, foil, connector, fiber and/or non-woven.

21. A medical product of claim 19, wherein said product releases less than about 5% of said active ingredient over a period of 15 days.
